(19) United States
(12) Patent Application Publication
(10) Pub. No.: US 2012/0027371 A1
(43) Pub. Date: Feb. 2, 2012

(54) VIDEO SUMMARIZATION USING VIDEO FRAMES FROM DIFFERENT PERSPECTIVES

(75) Inventors: Jay Hackett, Melbourne, FL (US); Tariq Bakir, Melbourne, FL (US); Jeremy Jackson, Melbourne, FL (US); Richard Cannata, Indian Harbor Beach, FL (US); Ronald Alan Riley, West Melbourne, FL (US)

(73) Assignee: Harris Corporation, Melbourne, FL (US)

(21) Appl. No.: 12/845,499

(22) Filed: Jul. 28, 2010

(51) Int. Cl. H04N 5/77

(52) U.S. Cl. 386/223; 386/224; 386/E05.002

(57) ABSTRACT

The video summarization system and method supports a moving sensor or multiple sensors by mapping imagery back to a common ortho-rectified geometry. The video summarization system includes at least one video sensor to acquire video data, of at least one area of interest (AOI), including video frames having a plurality of different perspectives. The video sensor may be a moving sensor or a plurality of sensors to acquire video data, of the at least one AOI, from respective different perspectives. A memory stores the video data, and a processor is configured to cooperate with the memory to register video frames from the AOI, ortho-rectify registered video frames based upon a common geometry, identify events within the ortho-rectified registered video frames, and generate a video summary of selected events shifted in time within a selected AOI based upon identified events within the ortho-rectified registered video frames.

### FIELD OF THE INVENTION

The present invention relates to the field of video technology, and more particularly, to video summarization of relevant activity captured by one or more video sensors at different perspectives.

### BACKGROUND OF THE INVENTION

Because watching video is very time-consuming, there have been many approaches for summarizing video. Several systems generate shorter versions of videos to support skimming. Interfaces supporting access based on keyframe selection enable viewing particular chunks of video. Video digital libraries use queries based on computed and authored metadata of the video to support the location of video segments with particular properties. Interactive video may allow viewers to watch a short summary of the video and to select additional detail on demand.

Video summary is an approach to create a shorter video summary from a long video. It may include tracking and analyzing moving objects (e.g. events), and converting video streams into a database of objects and activities. The technology has specific applications in the field of video surveillance where, despite technological advancements and increased growth in the deployment of CCTV (closed circuit television) cameras, viewing and analysis of recorded footage is still a costly and time-intensive task.

Video summary may combine a visual summary of stored video together with an indexing mechanism. When a summary is required, all objects from the target period are collected and shifted in time to create a much shorter synopsis video showing maximum activity. A synopsis video clip is generated in which objects and activities that originally occurred in different times are displayed simultaneously.

The process includes detecting and tracking objects of interest. Each object is represented as a worm or tube in space-time of all video frames. Objects are detected and stored in a database. Following a request to summarize a time period, all objects from the desired time are extracted from the database, and indexed to create a much shorter summary video containing maximum activity. To maximize the amount of activity shown in a short video summary, a cost function may be optimized to shift the objects in time.

Real time rendering is used to generate the summary video after object re-timing. An example of such video synopsis technology is disclosed in the paper by A. Rav-Ache, Y. Pritch, and S. Peleg, “Making a Long Video Short: Dynamic Video Synopsis”, CVPR'06, June 2006, pp. 435-441.

Also, in the article “Video Summarization Using R-Sequences” by Xinding Sun and Mohan S. Kankanhalli (Real-Time Imaging 6, 449-459, 2000), temporal summarization of digital video includes the use of representative frames to form representative sequences.

United States Patent Application 2008/0269924 to HUANG et al. entitled “METHOD OF SUMMARIZING SPORTS VIDEO AND APPARATUS THEREOF” discloses a method of summarizing a sports video that includes selecting a summarization style, analyzing the sports video to extract at least a scene segment from the sports video corresponding to an event defined in the summarization style, and summarizing the sports video based on the scene segment to generate a summarized video corresponding to the summarization style.

There is still a need for a video summary approach that can sift out the small amount of salient information from a large volume of irrelevant information and find frames of action between extended dull periods while accounting for the distortion due to the change in perspective of a moving sensor or from multiple sensors, e.g. such as airborne surveillance.

### SUMMARY OF THE INVENTION

It is an object of the present invention to provide a video summarization system and method that supports a moving sensor or multiple sensors by mapping imagery back to a common ortho-rectified geometry.

This and other objects, advantages and features in accordance with the present invention are provided by a video summarization system including at least one video sensor to acquire video data, of at least one area of interest (AOI), including video frames having a plurality of different perspectives. The video sensor may be a moving sensor or a plurality of sensors to acquire video data, of the at least one AOI, from respective different perspectives. A memory stores the video data, and a processor is configured to cooperate with the memory to register video frames from the AOI, ortho-rectify registered video frames based upon a common geometry, identify events within the ortho-rectified registered video frames, and generate a video summary of selected events shifted in time within a selected AOI based upon identified events within the ortho-rectified registered video frames.

The processor may be further configured to identify background within the ortho-rectified registered video frames and/or generate a surface model for the AOI to define the common geometry. The surface model may be a dense surface model (DSM). A display may be configured to display the generated video summary, and may also display selectable links to the acquired video data in the selected AOI.

Objects, advantages and features in accordance with the present invention are also provided by a computer-implemented video summarization method including acquiring video data with at least one video sensor, of at least one area of interest (AOI), including video frames having a plurality of different perspectives. Again, the video sensor may be a moving sensor or a plurality of sensors to acquire video data, of the at least one AOI, from respective different perspectives. The method includes storing the video data in a memory, and processing the stored video data to register video frames from the AOI, ortho-rectify registered video frames based upon a common geometry, identify events within the ortho-rectified registered video frames, and generate a video summary of selected events shifted in time within a selected AOI based upon identified events within the ortho-rectified registered video frames.

The processing may further include identifying background within the ortho-rectified registered video frames and/or generating a surface model, such as a dense surface model (DSM), for the AOI to define the common geometry. The method may also include displaying the generated video summary and/or displaying selectable links to the acquired video data in the selected AOI.

### BRIEF DESCRIPTION OF THE DRAWINGS

FIG. 1 is a schematic block diagram illustrating the video summarization system in accordance with an embodiment of the present invention.

FIG. 2 is a flowchart illustrating a sequence in a portion of the video summarization method of an embodiment of the present invention.

FIG. 3 is a flowchart illustrating a sequence in another portion of the video summarization method of an embodiment of the present invention.

FIGS. 4-6 are image representations illustrating an example of video frame registering in accordance with the method of FIG. 2.

FIGS. 7 and 8 are image representations illustrating an example of background estimation in accordance with the method of FIG. 2.

FIG. 9 is a schematic diagram illustrating further details of video summarization in the method in FIG. 3.

FIG. 10 is an image representation illustrating an example of actions/events/tracks for an AOI from video input that is mapped back to a common ortho-rectified geometry in the system and method of the present approach.

### DETAILED DESCRIPTION OF THE PREFERRED EMBODIMENTS

The present invention will now be described more fully hereinafter with reference to the accompanying drawings in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. The dimensions of layers and regions may be exaggerated in the figures for greater clarity.

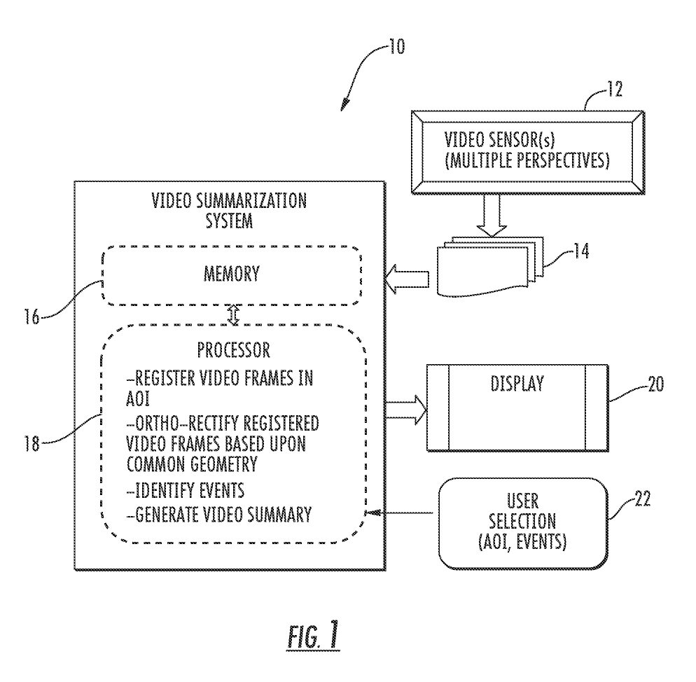

Referring initially to FIGS. 1-3, a video summarization system 10 and method will be described that supports a video sensor package 12, including a moving sensor or multiple sensors, by mapping imagery back to a common ortho-rectified geometry. The approach may support both FMV (Full Motion Video) and MI (Motion Imagery) cases, and may show AOI (areas of interest) restricted by actions/events/tracks and show original video corresponding to the selected action. Also, the approach may support real-time processing of video onboard an aircraft (e.g. UAV) for short latency in delivering tailored video summarization products.

The video summarization system 10 includes the use of at least one video sensor package 12 to acquire video data, of at least one area of interest (AOI), including video frames 14 having a plurality of different perspectives. As mentioned, the video sensor package 12 may be a moving sensor (e.g. onboard an aircraft) or a plurality of sensors to acquire video data, of the AOI, from respective different perspectives. A memory 16 stores the video data, and a processor 18 is configured to cooperate with the memory to register video frames from the AOI, ortho-rectify registered video frames based upon a common geometry, identify events within the ortho-rectified registered video frames, and generate a video summary of selected events shifted in time within a selected AOI based upon identified events within the ortho-rectified registered video frames.

The processor 18 may be further configured to identify background within the ortho-rectified registered video frames and/or generate a surface model for the AOI to define the common geometry. The surface model may be a dense surface model (DSM). A display 20 may be configured to display the generated video summary, and may also display selectable links to the acquired video data in the selected AOI. The AOI and actions/events within the AOI for summary may be selected at a user input 22.

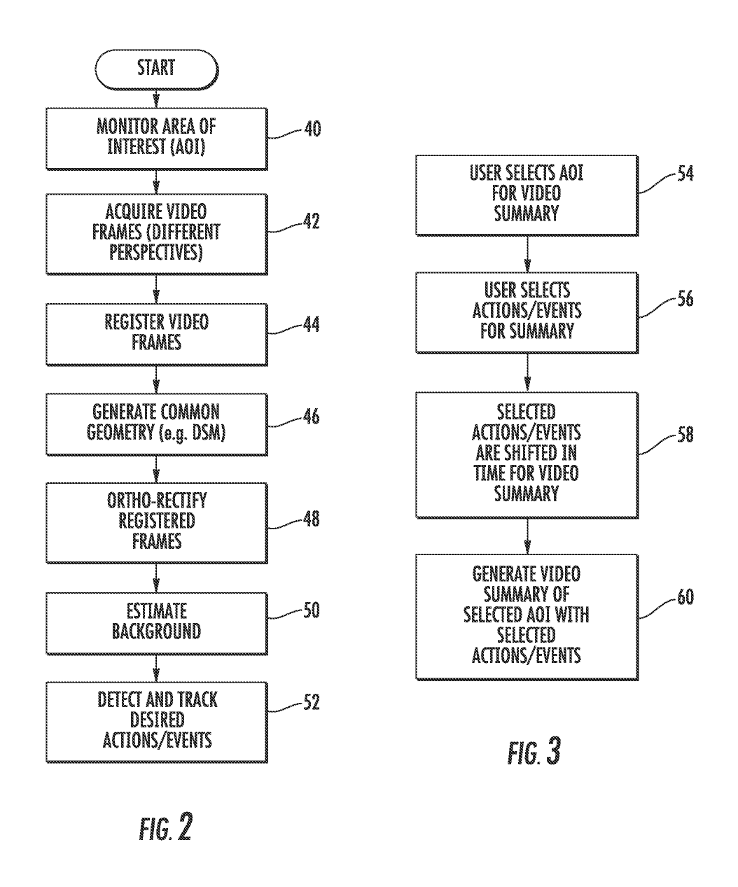

The computer-implemented video summarization method (e.g. FIG. 2) may include monitoring (block 40) an area of interest (AOI) and acquiring (block 42) video data with at least one video sensor package 12, of the AOI, including video frames 14 having a plurality of different perspectives. Again, the video sensor package 12 may be a moving sensor or a plurality of sensors to acquire video data, of the at least one AOI, from respective different perspectives.

Acquiring the video data preferably includes storing the video data in a memory 16. The stored video data is processed to register (block 44) video frames from the AOI, ortho-rectify (block 48) registered video frames based upon a common geometry (e.g. a DSM generated at block 46), identify events (blocks 50/52) by estimating the background (block 50) and detecting/tracking (block 52) actions/events within the ortho-rectified registered video frames.

Further, a user selects an AOI (block 54) and actions/events (block 56) for video summarization, e.g. using the user input 22. The selected actions/events are shifted in time (block 58) within a selected AOI based upon identified events within the ortho-rectified registered video frames to generate a video summary (block 60). The method may also include displaying the generated video summary and/or displaying selectable links to the acquired video data in the selected AOI.

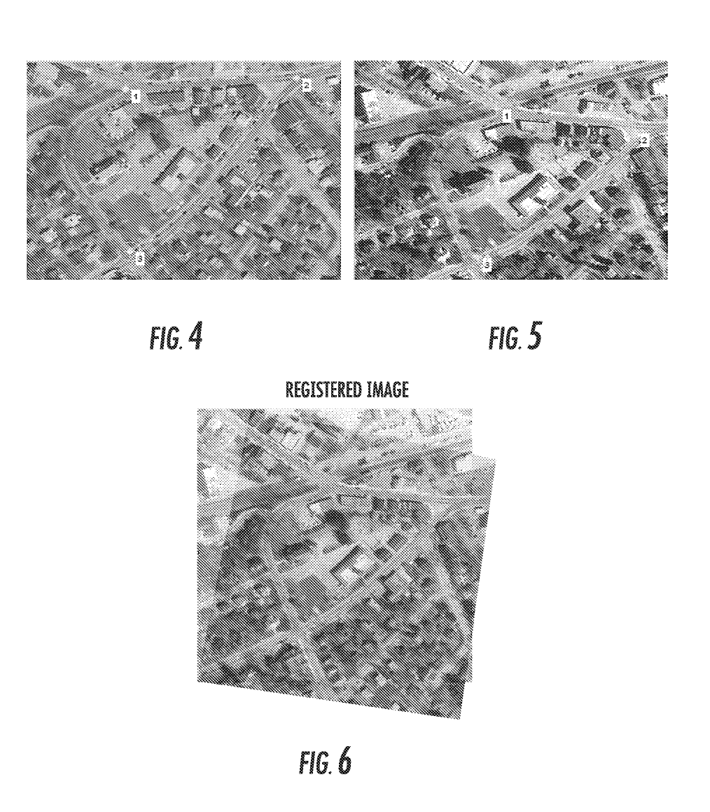

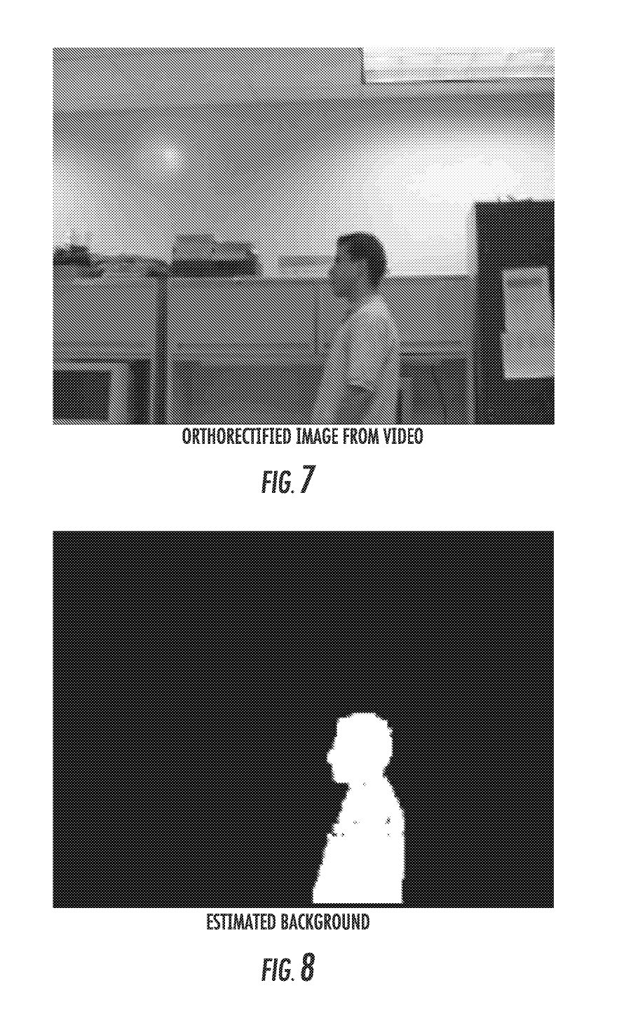

As is appreciated by those skilled in the art, registering the video frames (e.g. at block 44) may include a process of overlaying two or more images of the same scene taken at different times, from different viewpoints, and/or by different sensors. The process, e.g. with additional reference to FIGS. 4-6, typically includes geometrically aligning two images, a “reference” image and a “target” image. This may include feature detection, feature matching by invariant descriptors or correspondence pairs (e.g. points 1-3 in FIGS. 4 and 5), transformation model estimation (exploits the established correspondences), and image registration which involves an estimated transform applied to the “target” image and resampling (interpolation technique).

Some basic approaches are elevation based and may rely on the accuracy of recovered elevation from two frames or may attempt to achieve alignment by matching a DEM (Dense or Digital Elevation Model) with an elevation map recovered from video data. Also, image based approaches may include the use of intensity properties of both images to achieve alignment or the use of image features.

Some known frame registration techniques are taught in “Video Registration (The International Series In video Computing)” by Mubarak Shah and Rakesh Kumar, or “Layer-based video registration” by Jiangjian Xiao and Mubarak Shah. Also, “Improved Video Registration using Non-Distinctive Local Image Features” by Robin Hess and Alan Fern teaches another approach. Other approaches are included in “Airborne Video Registration For Visualization And Parameter Estimation Of Traffic Flows” by Anand Shastry and Robert Schowengerdy, or “Geodetic Alignment of Aerial Video Frames” by Y. Sheikh, S. Khan, M. Shah, and R. Cannata.

Generating the common geometry (e.g. block 46) or Dense/Digital Surface Model (DSM) may involve constructing a 3D understanding of a scene through the process of estimating depth from different projections. This may be commonly referred to as “depth perception” or “Stereosposis”. After calibration of the image sequence, triangulation techniques of image correspondences can be used to estimate depth. The challenge is finding dense correspondence maps.

Some techniques are taught in: “Automated reconstruction of 3D scenes from sequences of images” by. M. Pollefeys, R. Koch et al; “Detailed image-based 3D geometric reconstruction of heritage objects” by F. Remondino; “Automatic DTM Generation from Three-Line-Scanner (TLS) Images” By A. Gruen and I. Li; “A Review of 3D Reconstruction from Video Sequences” by Dang Trung Kien; “Bayesian Based 3D Shape Reconstruction From Video” by Nirmalya Gosh and Bit Bhanu; and “Time Varying Surface Reconstruction from Multiview Video” by S. Bilir and Y. Yemez.

Various types of topographical models are presently being used. One common topographical model is the digital elevation model (DEM). A DEM is a sampled matrix representation of a geographical area, which may be generated in an automated fashion by a computer. In a DEM, coordinate points are made to correspond with a height value. DEMs are typically used for modeling terrain where the transitions between different elevations, for example, valleys, mountains, are generally smooth from one to a next. That is, a basic DEM typically models terrain as a plurality of curved surfaces and any discontinuities therebetween are thus “smoothed” over. Another common topographical model is the digital surface model (DSM). The DSM is similar the DEM but may be considered as further including details regarding buildings, vegetation, and roads in addition to information relating to terrain.

One particularly advantageous 3D site modeling product is RealSite. from the Harris Corporation of Melbourne, Fla. (Harris Corp.), the assignee of the present application. RealSite. may be used to register overlapping images of a geographical area of interest and extract high resolution DEMs or DSMs using stereo and nadir view techniques. RealSite. provides a semi-automated process for making three-dimensional (3D) topographical models of geographical areas, including cities, that have accurate textures and structure boundaries. Moreover, RealSite. models are geospatially accurate. That is, the location of any given point within the model corresponds to an actual location in the geographical area with very high accuracy. The data used to generate RealSite. models may include aerial and satellite photography, electro-optical, infrared, and light detection and ranging (LIDAR), for example.

Another similar system from the Harris Corp. is LiteSite. LiteSite models provide automatic extraction of ground, foliage, and urban digital elevation models (DEMs) from LIDAR and synthetic aperture radar (SAR)/interfermetric SAR (IFSAR) imagery. LiteSite. can be used to produce affordable, geospatially accurate, high-resolution 3-D models of buildings and terrain.

Details of the ortho-rectification (e.g. block 48) of the registered video frames will now be described. The topographical variations in the surface of the earth and the tilt of a satellite or aerial sensor affect the distance with which features on the image are displayed. The more diverse the landscape, the more distortion inherent in the image frame. Upon receipt of an unrectified image, there is distortion across the image due to distortions from the sensor and the earth's terrain. By orthorectifying an image, the distortions are geometrically removed, creating a image that at every location has consistent scale and lies on the same datum plane.

Orthorectification is the process of stretching the image to match the spatial accuracy of a map by considering location, elevation, and sensor information. Aerial-acquired images provide useful spatial information, but usually contain geometric distortion.

Most aerial-acquired images show a non-orthographic perspective view. A perspective view gives a geometrically distorted image of the earth's surface. The distortion affects the relative position of objects and uncorrected data derived from aerial-acquired images. This will result in data not being directly overlaid to an accurate orthographic map.

Generally there are two typical Orthorectification processes. A parametric process involves knowledge of the interior and the exterior orientation parameters. A non-parametric process involves control points, polynomial transformation and perspective transformation. A polynomial transformation may be the simplest way available in most standard image processing systems to apply a polynomial function to the surface and adapt the polynomials to a number of checkpoints. Such technique may only remove the effect of tilt, and is applied to satellite images and aerial-acquire images.

For a perspective transformation, to perform a projective rectification, a geometric transformation between the image plane and the projective plane may be necessary. For the calculation of unknown coefficients of the projective transformation, at least four control points in the object plane may be required. This may be useful for rectifying aerial photographs of flat terrain and/or images of facades of buildings, but does not correct for relief displacement.

Some known ortho-rectifying approaches are taught in the following: “Generation of Orthorectified Range Images For Robots Using Monocular Vision and Laser Stripes” by J. G. N Orlandi and P. F. S Amaral; “Review of Digital Image Orthorectification Techniques” at www.gisdevelopment.net/technology/ip/fio_{—}1.htm; “Digital Rectification And Generation Of Orthoimages In Architectural Photogrammetry” by Matthias Hemmleb and Albert Wiedemann“; “Rectification of Digital Imagery, Review Article, Photogrammetric Engineering & Remote Sensing”, 1992, 58(3) 339-344 by K. Novak.

Estimating the background (e.g. block 50) will now be discussed in further detail with additional reference to FIGS. 7 and 8. The background model at each pixel location is based on the pixel's recent history, e.g. just the previous n frames. This may involve a weighted average where recent frames have higher weight. The background model may be computed as a chronological average from the pixel's history.

At each new frame, each pixel is classified as either foreground or background. If the pixel is classified as foreground, it is ignored in the background model. In this way, it prevents the background model from being polluted by pixels logically not belonging to the background scene. Some commonly known methods may include: Average, median, running average; Mixture of Gaussians; Kernel Density Estimators; Mean Shift; and Eigen Backgrounds.

Detecting and tracking desire actions/events or moving objects in the video frames (e.g. block 52) will now be discussed. The system may require knowledge and understanding of object location and types. In an ideal object detection and tracking system, knowledge of the background and the object(s) model(s) is useful to distinguish one from the other. The present system 10 may be able to adapt to a changing background due to the video frames taken from different perspectives.

Some known techniques are discussed in the following: “Object Tracking: A Survey” by Alper Yilmaz, Omar Javed, and Mubarak Shah; “Detecting Pedestrians Using Patterns of Motion and Appearance” by P. Viola, M. Jones, and D. Snow; “Learning Statistical Structure for Object Detection” by Henry Schneiderman; and “A General Framework for Object Detection” by P. C Papagerogiou, M. Oren, and T. Poggio.

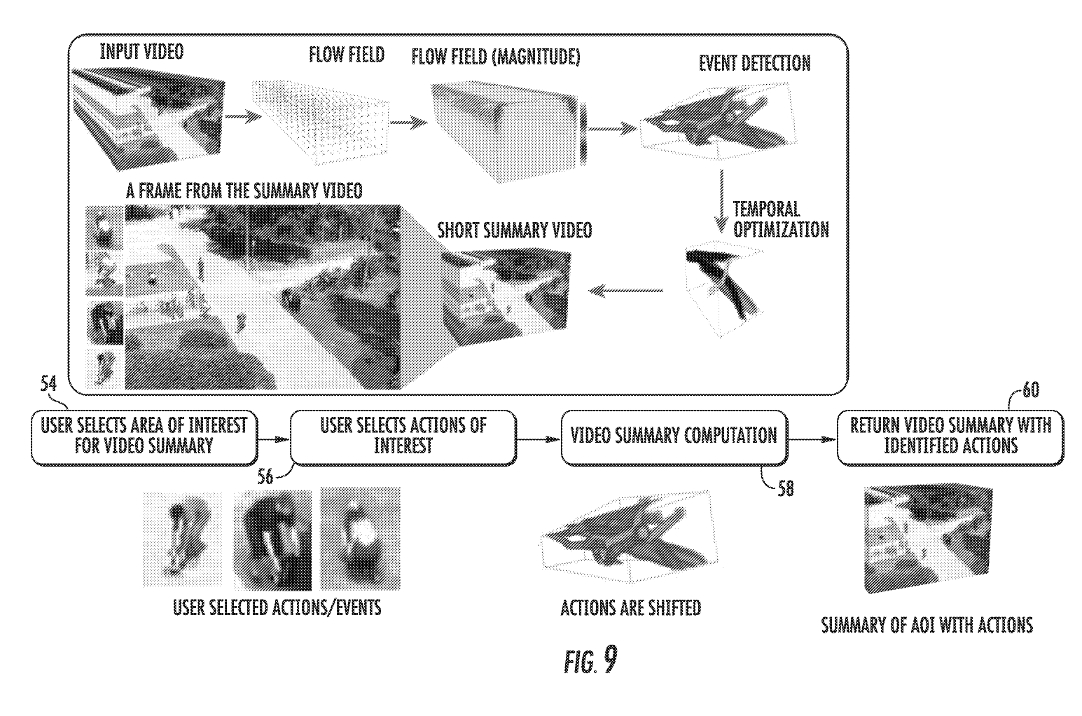

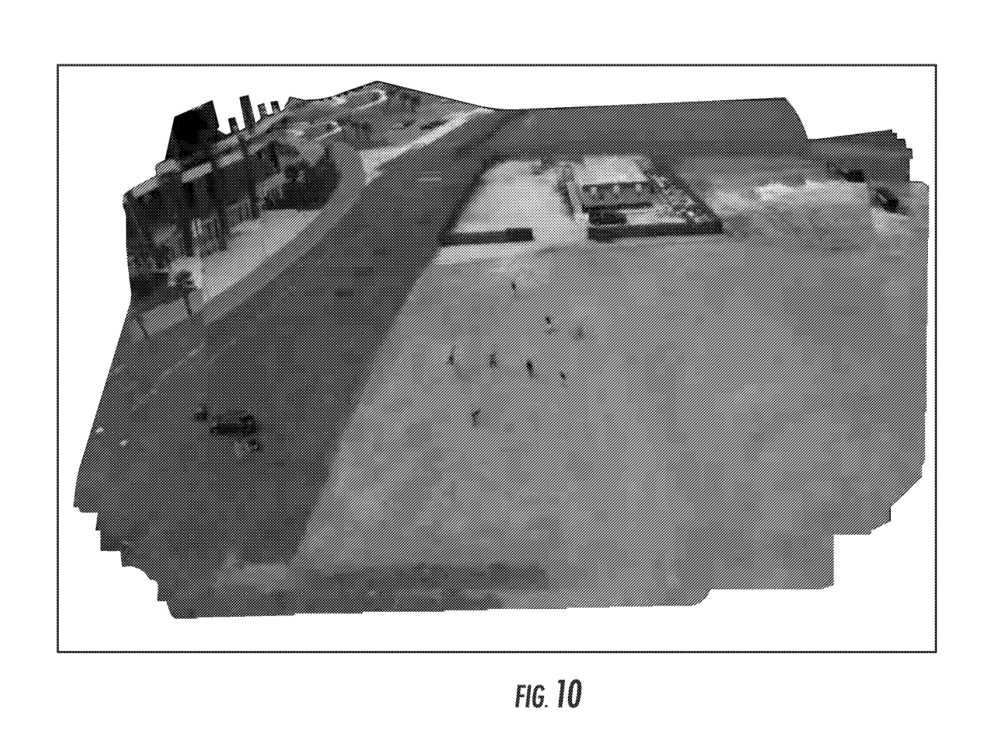

Referring now to FIG. 9, further details of the method steps in FIG. 2 will be discussed. A user selects an AOI (block 54) for video summary from a video that is acquired or input and processed in the system 10 as described above. The user selects an action/event (i.e. an activity of interest) at block 56, for example, a “picking up” action may be selected. To generate the video summarization, a flow field in the Clifford-Fourier domain may be computed where each of the tracks/worms occur in the video. A MACH filter based on a training set for a specific action is then compared to the flow field for each worm via Clifford convolution. A match track/worm is classified as that activity.

Clifford convolution and pattern matching is described in the paper “Clifford convolution and pattern matching on vector fields” by J. Ebling and G. Scheuermann. Details of the MACH filter version of Clifford convolution and pattern matching may be found in the paper: “Action MACH a spatio-temporal Maximum Average Correlation Height filter for action recognition” by M. Rodriquez, J. Ahmed, and M. Shah.

Dynamic regions (or Clifford worms) are identified, and a temporal process shifts worms which contain activities of interest, to obtain a compact representation of the original video. A resulting short video clip that contains the instances of the action is returned for display. For example, FIG. 10 illustrates a still shot of the actions/events/tracks for an AOI from video input that is mapped back to a common ortho-rectified geometry in the present approach.

Some known techniques may be described in the following: “CRAM: Compact Representation of Actions in Movies” by Mikel Rodriguez at UCF, http://vimeo.com/9761199; “Summarizing Visual Data Using Bidirectional Similarity” by Denis Simakov et al.; “Hierarchical video content description and summarization using unified semantic and visual similarity” by Xingquan Zhu et al; “Hierarchical Modeling and Adaptive Clustering for Real-Time Summarization of Rush Videos” by Jinchang Ren and Jianmin Jiang; and “Unsupervised Learning of Human Action Categories Using Spatial-Temporal Words” by J. Niebles et al.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. A video summarization system comprising:
a video sensor operable to acquire video data, of at least one area of interest (AOI), including video frames having a plurality of different perspectives;
a memory operable to store the video data; and
a processor configured to
cooperate with the memory to register video frames from the AOI,
ortho-rectify registered video frames based upon a common geometry,
identify events within the ortho-rectified registered video frames, and
generate a video summary of selected events shifted in time within a selected AOI based upon identified events within the ortho-rectified registered video frames.

2. The video summarization system according to claim 1, wherein the processor is further configured to identify background within the ortho-rectified registered video frames.

3. The video summarization system according to claim 1, wherein the processor is further configured to generate a surface model for the AOI to define the common geometry.

4. The video summarization system according to claim 3, wherein the surface model comprises a dense surface model (DSM).

5. The video summarization system according to claim 1, further comprising a display configured to display the generated video summary.

6. The video summarization system according to claim 5, wherein the display is further configured to display selectable links to the acquired video data in the selected AOI.

7. The video summarization system according to claim 1, wherein the video sensor comprises a plurality of video sensors operable to acquire video data, of the at least one AOI, from respective different perspectives.

8. The video summarization system according to claim 1, wherein the video sensor comprises a mobile video sensor operable to acquire video data, of the at least one AOI, from different perspectives.

9. A video summarization system comprising:
a memory operable to store acquired video data, of at least one area of interest (AOI), including video frames having a plurality of different perspectives; and
a processor configured to
cooperate with the memory to register video frames from the AOI,
ortho-rectify registered video frames based upon a common geometry,
identify events within the ortho-rectified registered video frames, and
generate a video summary of selected events shifted in time within a selected AOI based upon identified events within the ortho-rectified registered video frames.

10. The video summarization system according to claim 9, wherein the processor is further configured to identify background within the ortho-rectified registered video frames.

11. The video summarization system according to claim 9, wherein the processor is further configured to generate a surface model for the AOI to define the common geometry.

12. The video summarization system according to claim 11, wherein the surface model comprises a dense surface model (DSM).

13. The video summarization system according to claim 9, wherein the acquired video data comprises video data acquired from a plurality of video sensors from respective different perspectives of the at least one AOI.

14. The video summarization system according to claim 1, wherein the acquired video data comprises video data acquired from a mobile video sensor from different perspectives of the at least AOI.

15. A computer-implemented video summarization method comprising:
acquiring video data with a video sensor, of at least one area of interest (AOI), including video frames having a plurality of different perspectives;
storing the video data in a memory;
processing the stored video data to
register video frames from the AOI,
ortho-rectify registered video frames based upon a common geometry,
identify events within the ortho-rectified registered video frames, and
generate a video summary of selected events shifted in time within a selected AOI based upon identified events within the ortho-rectified registered video frames.

16. The computer-implemented video summarization method according to claim 15, wherein the processing further includes identifying background within the ortho-rectified registered video frames.

17. The computer-implemented video summarization method according to claim 15, wherein the processing further includes generating a surface model for the AOI to define the common geometry.

18. The computer-implemented video summarization method according to claim 17, wherein generating the surface model comprises generating a dense surface model (DSM).

19. The computer-implemented video summarization method according to claim 15, further comprising displaying the generated video summary.

20. The computer-implemented video summarization method according to claim 19, wherein displaying further includes displaying selectable links to the acquired video data in the selected AOI.

21. The computer-implemented video summarization method according to claim 15, wherein acquiring video data includes the use of a plurality of video sensors to acquire the video data, of the at least one AOI, from respective different perspectives.

22. The computer-implemented video summarization method according to claim 15, wherein acquiring video data includes the use of a mobile video sensor to acquire the video data, of the at least one AOI, from different perspectives.

23. A computer-implemented video summarization method comprising:
storing acquired video data in a memory, of at least one area of interest (AOI), including video frames having a plurality of different perspectives; and
processing the stored video data to
register video frames from the AOI,
ortho-rectify registered video frames based upon a common geometry,
identify events within the ortho-rectified registered video frames, and
generate a video summary of selected events shifted in time within a selected AOI based upon identified events within the ortho-rectified registered video frames.

24. The computer-implemented video summarization method according to claim 23, wherein processing further includes identifying background within the ortho-rectified registered video frames.

25. The computer-implemented video summarization method according to claim 23, wherein processing further includes generating a surface model for the AOI to define the common geometry.

26. The computer-implemented video summarization method according to claim 25, wherein generating the surface model comprises generating a dense surface model (DSM).

27. The computer-implemented video summarization method according to claim 23, wherein storing the acquired video data comprises storing video data acquired from a plurality of video sensors from respective different perspectives of the at least one AOI.

28. The computer-implemented video summarization method according to claim 23, wherein storing the acquired video data comprises storing video data acquired from a mobile video sensor from different perspectives of the at least AOI.
